(19) United States
(12) Patent Application Publication
(10) Pub. No.: US 2010/0268574 A1
(43) Pub. Date: Oct. 21, 2010

(54) TRACKING USER PROFILE INFLUENCE IN A DIGITAL MEDIA SYSTEM

(75) Inventors: Thomas C. Butcher, Seattle, WA (US); Jessica Zahn, Renton, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/425,770

(22) Filed: Apr. 17, 2009

(51) Int. Cl. G06Q 30/00; G06N 7/02; G06Q 10/00

(52) U.S. Cl. 705/10; 706/52; 709/224; 705/14.66

(57) ABSTRACT

Methods and systems for tracking user profile influence in a digital media system are provided. One exemplary method includes computing connection weights of connections between a plurality of user nodes, each user node representing a user profile of the digital media system, to thereby generate an influence network. The connection weights may be based on implicit activity notifications received at a media server via a plurality of media clients associated with the user nodes. The method may further include calculating a dynamic influence score for each of the user nodes based on the connection weights between the user nodes in the influence network. The method may further include comparing the dynamic influence scores to an influence score threshold to determine one or more lead user nodes, and sending an influence reward to the media clients associated with the one or more lead user nodes.

### BACKGROUND

Every day, vast amounts of digital media are shared, purchased, and recommended to users in networked social environments. Networked social environments assist users in discovering new digital media including songs, videos, podcasts, etc., by allowing them to view what other users have enjoyed.

One drawback with user-to-user, or peer-to-peer, discovery of digital media through social networking is that such a process may be undetectable, or opaque, to a media content provider. As a result, the media content provider may be dependent on the users' media discovery behavior, and may be unable to effectively predict media trends. Thus, when “tastemaker” users contributing to trend establishment leave the social network for a competing network, other users experience a loss in media discovery resources (i.e., tastemaker users). This may have a “domino effect”, in that the remaining users may have a less positive experience with the social network for media discovery and may also leave the social network, thereby leading to an overall reduced effectiveness of the social network for media discovery. If music is also sold within such a social network, loss of tastemaker users to a competing network may also lead to loss of sales.

### SUMMARY

Methods and systems for tracking and rewarding user profile influence in a digital media system are provided. One exemplary method includes computing connection weights of connections between a plurality of user nodes, each user node representing a user profile of the digital media system, to thereby generate an influence network. The connection weights may be based on implicit activity notifications received at a media server via a plurality of media clients associated with the user nodes. The method may further include calculating a dynamic influence score for each of the user nodes based on the connection weights between the user nodes in the influence network. The method may further include comparing the dynamic influence scores to an influence score threshold to determine one or more lead user nodes, and sending an influence reward to the media clients associated with the one or more lead user nodes.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic view of a digital media system for tracking user influence and rewarding user influence in a digital media system.

FIG. 2 is a flowchart illustrating a method for tracking and rewarding user influence in a digital media system.

FIG. 3 is a schematic view of an exemplary influence network.

### DETAILED DESCRIPTION

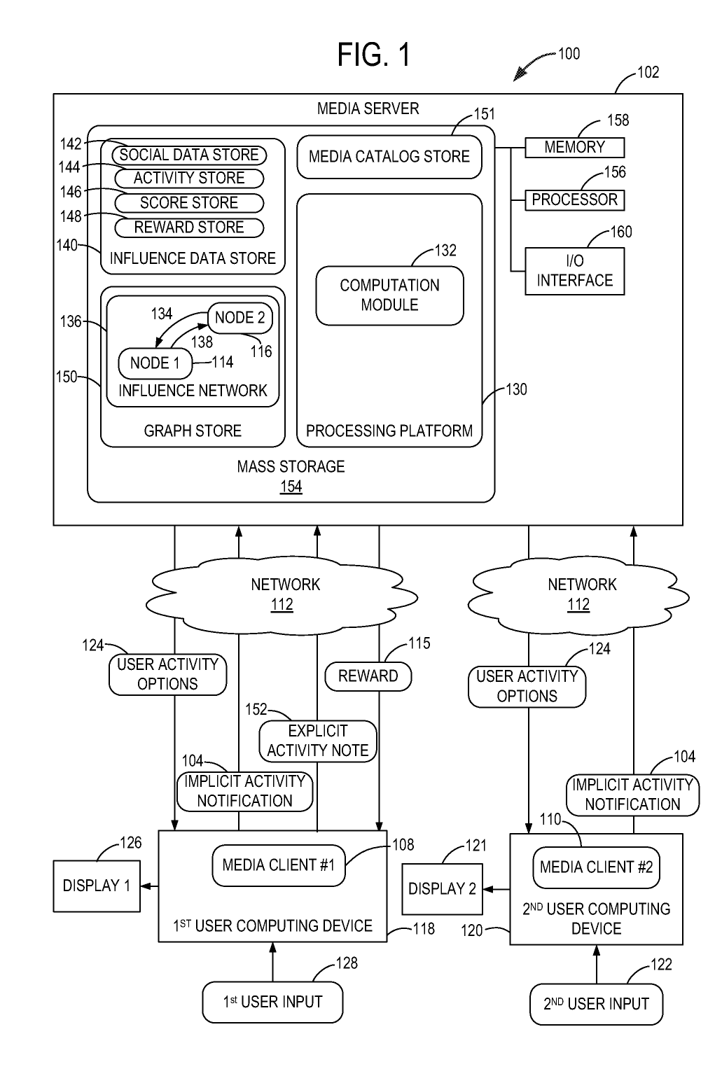

FIG. 1 illustrates a digital media system 100 for tracking user profile influence. The digital media system 100 may include a media server 102 configured to receive implicit activity notifications, such as implicit activity notification 104, from a plurality of media clients such as a first media client 108 and a second media client 110, via a network 112 (e.g., local area network, Internet, etc.).

Media clients (e.g., a media discovery software tool) may be operable on mobile computing devices such as portable media players, mobile telephones, portable data assistants, etc., or personal computing devices such as laptop and desktop computers, and may interface with a media server 102 via a computer network 112. It may be further appreciated that media client operating sources can be software-developer computing devices, third party computing devices, and/or network-based platforms.

The media client may be in the form of an executable application program in a multi-program desktop operating environment, or as a dedicated application that runs on a portable device, for example. Each media client may be used by one or more users, each of whom create user accounts via the media client so that the media client can customize the user experience for each user.

As one example, a media client may be a social networking tool for music discovery. This may be a software application downloadable to a user computing device, such as those described above, and/or an application residing on another computing device accessible to a user via a network. Thus, when a user accesses the software application, the user can become friends with other users by self-selection, recommendation, etc. Users can browse and search for music they like from a generic library, their friends' libraries of music, friends' recommendations, etc. The user may also sample a portion or all of music the user is interested in, by clicking on a link to a music track or album. If a user likes a particular music track or album, the user may download the track or album for no cost, and/or via a financial transaction or other form of payment. Alternately, the user may flag the music track or album as a reminder to return to it, and/or to mark it as a favorite.

As will be appreciated from the description herein, a plurality of user nodes are established at the media server, where each user node represents a user profile associated with a user account of the digital media system 100. The establishment of user nodes, such as first user node 114 and second user node 116, at the media server 102 allows the media server 102 to track user profile influence among all user profiles.

One way of tracking user profile influence is by having each media client associated with at least one of the plurality of user nodes. For example, if a first user profile associated with a first user account and a second user profile associated with a second user account access first media client 108 operating on a user computing device 118 such as a mobile phone, the first user node 114 and second user node 116 are established at the media server 102 and each of the first user node 114 and second user node 116 at the media server 102 are associated with the first media client 108 operating on the mobile phone. Each user node can also be associated with more than one media client. For example, the second user profile may access first media client 108 operating on first user computing device 118 and second media client 110 operating on second user computing device 120. Thus, the second user profile will be associated with both the first media client 108 and the second media client 110, such that activity carried out responsive to second user input 122 received at both the first media client 108 and second media client 110 is associated with the second user node 116 at the media server 102.

Implicit activity notification 104 may be received at the media server 102 responsive to detection of performance of one or more implicit activities via the respective media clients. Implicit activities are referred to as such with respect to a particular user. For example, for a first user and a second user, an activity carried out by the first user is considered an implicit activity with respect to the second user if there exists a relation between the first and second user. Such a relation may include a friend relation, visible and known to both the first and second user. A relation may also exist, invisible to the first user and second user, having been created at the media server and represented by a connection between respective user nodes, because the first user views the second user's profile card.

Thus, implicit activities performed via a first media client 108 may include a plurality of activities, such as a play of a second user profile-associated media item. A play of a second user profile-associated media item may be a play of a media item from the second user profile card (e.g., a second user profile card may include items that the second user profile has played, rated, and/or recommended), or from the second user profile's friends list. Further, a play of a public media item from a public listing of public media items may also be considered a play of a second user profile-associated media item, if the public media item is associated with the second user profile and the first user profile has a predefined relation to the second user profile (e.g., first user profile has viewed second user profile's card, first user profile has a friendship or fan-ship with the second user profile, etc.). As a specific example, user activity options 124 such as “play user #5's favorite song” and/or “send user #21's playlist to my friends” may be sent to first media client 108 and displayed on a first display 126 associated with first user computing device 118. Thus, first user input 128 may be received at the first media client 108 to perform an activity defined as one of the implicit activities. Responsive to the performance of the implicit activity (which may occur via the media client 108 at the media client 108 and/or at the media server 102), implicit activity notification 104 is sent to the media server 102. User activity options 124, which may be tailored for each user profile, may similarly be sent to second media client 110 operating on second user computing device 120 and displayed on a second display 121 associated with second user computing device 120.

Other implicit activities performed by first media client 108 may include syncing of a second user profile card, rating of a second user profile-associated media item, and/or sending of a second user profile-associated media item. Rating of a second user profile-associated media item may include a positive or negative rating of a shared playlist, a sent song, a sent album, or a sent playlist. The sending of a second user profile-associated media item may include sending digital items, such as songs, albums, videos, files, or playlists associated with the second user profile to an inbox of the first user profile or to a third user profile. The sending of digital media items may be public or private. For example, a playlist send may be a public playlist send or a personal playlist send. A public playlist send may include sending a playlist generated at the server, from the server, to one or more media clients. In contrast, a personal playlist send may include the sending of a user-generated playlist to one or more recipients, where the recipients are users of a media client.

Furthermore, playlists can be sent to any user of a media client, or to all users of a media client such that the playlist is discoverable and viewable by all users of a media client. Alternately, playlist can be sent to one or more recipients, where the recipients are users of a media client, and where the one or more users are selected by the sender. In the case where the recipients of a playlist send are selected by the sender, the playlist may not be discoverable by all users of a media client, and the playlist may be available only to recipients specified by the sender.

Further still, implicit activities performed via first media client 108 associated with a first user profile may include fan addition and/or friend addition of a second user profile, and fan removal and/or friend removal of a second user profile. As an example, first media client 108 provides a social networking program for music discovery and fan addition may be performed responsive to first user input 128 when a first user profile locates an artist profile of which the first user profile is fond of and adds him/herself as a fan of the artist profile, thus initiating a “fan-ship”. Similarly, a friend addition may be performed responsive to first user input 128 when a first user profile desires to be a friend with a second user profile, thus initiating a “one-way friendship” until or unless the second user profile indicates by second user input 122 that the second user profile desires to be a friend with said first user profile, at which point the one-way friendship may become a mutual friendship. Fan removal and/or friend removal also be performed. For example, a fan-ship can be removed by a user profile (who, for example, initially requested the fan-ship) requesting, at a media client, to end the fan-ship. Similarly, a mutual friendship can be removed when one or both of the user profiles in a mutual friendship request a friend removal. In another example, a mutual friendship can become a one-way friendship if one of the user profiles in the mutual friendship indicates, by user profile input, to remove the other user profile in the mutual friendship as a friend.

To track user profile influence, the media server 102 may include a processing platform 130, which may contain a computation module 132, configured to compute connection weights of connections (e.g., connection 134, connection 138) between the plurality of user nodes representing user profiles of the digital media system 100 to thereby generate an influence network 136. The connection weights of the connections are based on the implicit activity notifications received at the media server 102. Furthermore, implicit activities may be weighted, such that certain types of implicit activities affect connection weights more than others, or such that some implicit activities negatively affect a connection weight while others positively affect a connection weight. Further, connection weights may be based on recency and/or frequency of implicit activity performance. In one example, a first user profile and a second user profile have a mutual friendship; accordingly, the connection weight of the connection 138 from the first user node 116 to the second user node 114 is affected by the first user profile's implicit activities. Specifically, if the first user profile performs a high level of positive implicit activities, the connection weight of the connection 134 from the first user node 114 to the second user node 116 will be positively increased. Similarly, the connection weight of the connection 134 from the second user node 116 to the first user node 114 may be affected by the second user profile's implicit activities.

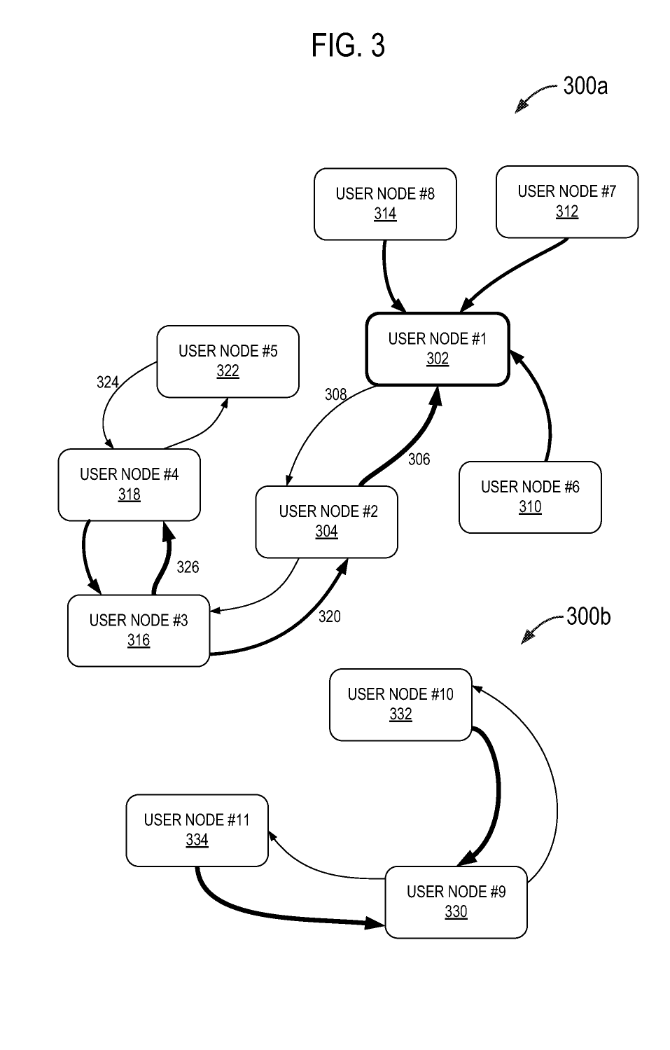

Connections (e.g., connection 134, connection 138) in the influence network 136 have connection directionalities, where a unidirectional connection between two user nodes indicates a one-way friendship between a first user node and a second user node or a one-way fan-ship between a first user node and a second user node. Alternately, a connection directionality may be bidirectional, where a bidirectional connection indicates a mutual friendship between a first user node and a second user node. In this example, a bidirectional connection is indicated by two oppositely-pointed arrows between first user node 114 and second user node 116. An exemplary influence network illustrating different types of connections and connection weights between user nodes will be discussed in detail with respect to FIG. 3.

The processing platform 130 of the media server 102 may also be configured to interoperate with influence data store 140 containing a social data store 142, user activity store 144, influence scores store 146, and reward store 148. The processing platform 130 may be further configured to interoperate with graph store 150, in addition to influence data store 140 and/or several media clients such that the influence network 136 can be accessed, updated, and stored efficiently.

In order to determine a level of a user profile's influence in the influence network 136, the processing platform 130 may be further configured to calculate a dynamic influence score for each user node based on connection weights between each user node and one or more other user nodes of the influence network. Dynamic influence scores for each user node may also be based on connectedness factors of connections between each user node and the other user nodes, such as the connection directionalities, described above. Other connectedness factors that may affect the dynamic influence score of a user node include factors that generally relate to the breadth and depth of the influence network. Some of these connectedness factors include connection durations (e.g., how long a friendship or fan-ship has existed), connection distances (e.g., how many user nodes are between one user node and another), a number of connections, a number of connections with active user nodes (e.g., nodes associated with user profiles active on a media client within a predetermined period of time) the dynamic influence scores of other user nodes (e.g., “downstream” user nodes), and user computing device type associated with each user node (e.g., type of device the media client associated with the user node is operating on). Thus, the dynamic influence score of the first user node is determined by the activities of user profiles other than the first user profile because the connection weights of connections between a first user node and downstream user nodes are based on the implicit activities of the downstream user nodes.

The processing platform 130 may compare the dynamic influence scores to an influence score threshold to determine one or more lead user nodes from the plurality of user nodes, and the media server 102 may send an influence reward 115, from reward store 148, to one or more media clients associated with the one or more lead user nodes. The sending of influence rewards may encourage the one or more lead user profiles to continue their positive and/or influential behavior and may motivate other user profiles to become influential. Influence rewards may include influence badges, free or discounted media, increased media client functionality, etc. For example, an influence reward (e.g., media item) may be extracted from the media catalog store 151 by the processing platform 130 for sending to a lead user profile. Media catalog store 151 may be further configured to interoperate with the influence data store 140, and the graph store 150 when appropriate.

In some examples, the connection weights of connections in the influence network may also be based on explicit activity notifications, such as explicit activity notification 152, received at the media server 102 from a first user media client 108 responsive to execution of one or more explicit activities via the first user media client 108. That is, connection weights between first user node 114 and other user nodes (e.g., second user node 116) may also be affected by the first user profile's own activities (e.g., explicit activities), in addition to other user profiles' activities (i.e. second user profile's implicit activities) in some examples. As a result, the influence score of the first user node 114 may thereby be determined by the activities of user profiles other than the first user profile in addition to activities by the first user profile itself.

Explicit activities can include a friend removal, a friend addition, sending of a first user profile-associated media item, and/or sending of a first user profile-associated media playlist. Friend removal may be executed, or performed, when a first user profile provides first user input 128 via a first media client 108 to remove a friend, and friend addition may be executed when a first user profile provides first user input 128 indicating a desire to be a friend with a second user profile. Thus, when a second user profile is added as a friend, the second user profile's dynamic influence score is affected not only by the second user profile's subsequent implicit activities with respect to the first user profile, but also simply by the addition of the second user profile as a friend. This is especially the case if the second user node 116 associated with the second user profile itself has a high dynamic influence score.

Furthermore, connection weights can be based on recency and/or frequency of explicit activity execution. However, in order to discourage spamming (e.g., frequently sending media items, playlists, etc. to many other user profiles), connection weights may not be positively increased by frequency of explicit activity execution if said explicit activities are not well-received by the other user profiles. For example, if a first user profile sends recommended playlists to many other user profiles every day, and the playlists are rated poorly or there are complaints by the many other user profiles, the connection weights between the first user profile and the many other user may not be strengthened and may even be weakened.

It will be appreciated that the processing platform 130, influence data store 140, graph store 150, and/or media catalog store 151, and/or some media clients and various respective software components described above may be stored in a mass storage 154 and executed on a processor 156 using portions of memory 158 and may further be configured to communicate with software on other computing devices across one or more computer networks 112, via input/output module 160. It will further be appreciated that the media server 102 may be a single server, or multiple distributed servers interoperating across one or more computer networks 112 (e.g., Local area network, Internet, etc.), and the components of processing platform 130, influence data store 140, graph store 150, media catalog store 151, and/or some media clients may be implemented on these distributed devices. In alternate examples, several different computer networks may be used for transmission of user activity options, implicit activity notifications, explicit activity notifications, influence rewards, etc.

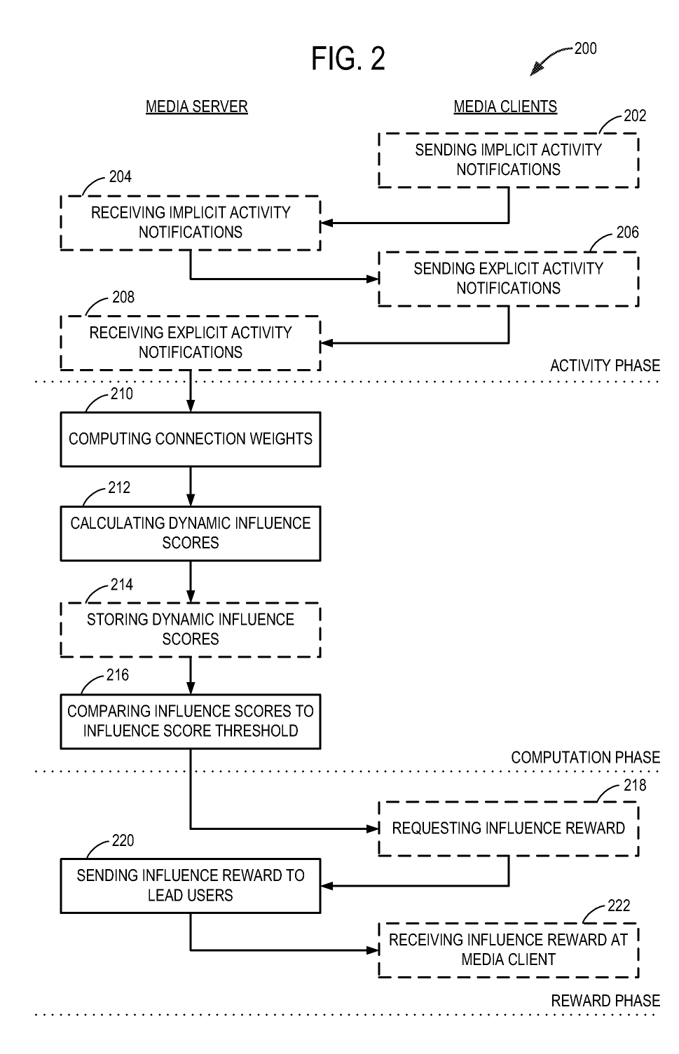

Referring now to FIG. 2, a flowchart illustrates an exemplary method 200 for tracking user profile influence in a digital media system. Method steps on the left hand side of the flowchart are executed at a media server and steps on the right hand side may be executed by one or more of a plurality of media clients. As illustrated, the method includes three phases including an activity phase in which implicit and explicit activity notifications are sent, a computation phase in which connection weights and dynamic influence scores are calculated, and a reward phase in which influence rewards may be received at a media client. It may be understood that the phases may occur concurrently and/or asynchronously. That is, a step in the flowchart may not depend on a preceding step of the flowchart, and a phase of the flowchart may not depend on a preceding phase. Steps and/or phases of the flowchart may occur in any order.

At 202, the method may include sending implicit activity notifications from a plurality of media clients to a media server, where the implicit activity notifications are received at 204, the notifications being associated with respective user nodes at the media server. For example, implicit activity notifications may be received at the media server from a first user media client associated with a first user node responsive to performance of one or more of the implicit activities via the first user media client. The implicit activities may include a play of a second user profile-associated media item, syncing of a second user node profile card, rating of a second user profile-associated media item, sending of a second user profile-associated media item, fan addition and/or friend addition of a second user profile, and fan removal and/or friend removal of a second user profile, as described above.

At 206, the method 200 may include sending explicit activity notifications from media clients, and receiving the explicit activity notifications 208 at the media server. For example, explicit activity notifications may be received at the media server from a first user media client associated with a first user node responsive to execution of one or more of the following explicit activities via the first user media client: a friend removal, a friend addition, a first user profile-associated media item send, and a first user profile-associated media playlist send.

The method includes, at 210, computing connection weights of connections between a plurality of user nodes representing user profiles of the digital media system to thereby generate an influence network. Connection weights of the connections in the influence networks are based on the implicit activity notifications, and also on explicit activity notifications in some cases. Accordingly, connection weights can be further based on recency and/or frequency of implicit activity performance, and recency and/or frequency of explicit activity execution.

At 212, the method 200 includes calculating a dynamic influence score for each of the user nodes, for example at computation module of a media server (such as computation module 132 of FIG. 1) based on the connection weights between the user nodes in the influence network. The calculation of dynamic influence scores may be based on connectedness factors of connections between each user node and other user nodes. One connectedness factor may be the connection directionalities, where a unidirectional connection indicates a one-way friendship between a first user node and a second user node or a one-way fan-ship between a first user node and a second user node, and where a bidirectional connection indicates a mutual friendship between a first user node and a second user node. Other connectedness factors may include connection durations, connection distances, number of connections, a number of connections with active user nodes, media client operating sources associated with the user nodes, and dynamic influence scores of the other user nodes, as discussed above.

At 214, the method may include storing dynamic influence scores at an influence data store. Further, connection weights and/or other features of an influence network may be stored. At 216, the method 200 includes comparing the dynamic influence scores to an influence score threshold, at a computation module (such as computation module 132) of the media server, to determine one or more lead user nodes. At 218, the method may include requesting an influence reward at a media client, for example, programmatically when a dynamic influence score reaches a predetermined level. In another example, a media client may request an influence reward request via user input. The method further includes, at 220, sending an influence reward from the media server to the media clients associated with the one or more lead user nodes. At 222, the method includes receiving an influence reward at one of a plurality of media clients associated with a lead user node, from a media server. Thus, it may be appreciated that FIG. 2 also illustrates a flowchart for an exemplary method for rewarding user influence in a digital media system, where the method includes receiving a reward at one of a plurality of media clients associated with a target user node when a dynamic influence score of the target user node exceeds a dynamic influence score threshold. In this case, “target user node” refers to the user node of interest when calculating a dynamic influence score.

Referring now to FIG. 3, an exemplary influence network 300a is illustrated. User nodes may be referred to as target user nodes when calculating a dynamic influence score. Once the dynamic influence scores are calculated, it is determined that user node #1 302 is a lead user based on a comparison of the dynamic influence score of user node #1 302 to a dynamic influence score threshold, and that the remaining user nodes are follower users.

The dynamic influence scores are based on connection weights of connections between the user nodes. Connections are illustrated by arrows in FIG. 3, where the arrow tail is connecting a user node associated with the user profile performing implicit activities related to the user node at the arrow head. That is, connection 306 indicates that user node #2's implicit activities affect, or are “feeding” user node #1's dynamic influence score. Connection weights are illustrated by arrow thickness in FIG. 3, where a thick arrow indicates a strong connection and a thin arrow indicates a weaker connection.

Here, user node #1 302 has a mutual friendship with user node #2 304 indicating that the user nodes reciprocally influence each other. The connection weight of the connection 306 from user node #2 304 to user node #1 302 is high because user node #2's implicit activities with respect to user node #1 302 are highly weighted, frequent and/or recent. That is, user node #2 304 is performing more highly-weighted implicit activities, more frequent implicit activities, or more recent implicit activities with respect to user node #1 302 than user node #1 302 is performing with respect to user node #2 304. In other words, user node #1 302 has a greater influence on the activities of user node #2 304, evidenced by the thickness of connection 306 compared to connection 308. As a result, the activities of user node #2 304 are greatly affecting the dynamic influence score of user node #1 302.

User node #6 310, user node #7 312, and user node #8 314 have one-way friendships with user node #1 302, indicating that the implicit activities of user node #6 310, user node #7 312, and user node #8 314 have an effect on user node #1's dynamic influence score. In other words, user node #6, user node #7, and user node #8 are carrying out implicit activities that are related to user node #1 (e.g., playing music associated with user node #1). Yet another way of describing this relationship is that user node #1 302 is influencing the activities of user node #6 310, user node #7 312, and user node #8 314. However, as indicated by the absence of bidirectional connections, user node #1 302 is not carrying out implicit activities related to user nodes #6-8, and thus user node #1's activities do not have an effect on the dynamic influence scores of user nodes #6-8.

It may be appreciated that initiation of a friendship or fan-ship is not a prerequisite in order for two user nodes to have a connection. The connections in an influence network may be formed by one or another user profile's request for a fan-ship or friendship and/or by implicit activities. For example, user profile #1 associated with user node #1 302 may not have requested a friendship with user profile #6 associated with user node #6 310, nor has user profile #6 requested a friendship with user profile #1. However, user profile #6 has, perhaps, viewed user profile #1's user profile card at some time, and frequently plays music that user profile #1 plays. Thus, the connection between user node #6 310 and user node #1 302 may be formed simply by the implicit activities (e.g., song plays) carried out by user profile #6.

User node #3 316 has a mutual friendship with user node #2 304, where connection 320 indicates that user node #2 304 has a high influence on the activities of user node #3 316. Because user node #1 302 greatly influences user node #2 304, and user node #2 304 greatly influences user node #3 316, user node #1 302 is also highly influential on user node #3 316. This is reflected in user node #1's dynamic influence score.

User node #3 316 also has a mutual friendship with user node #4 318. Thus, user node #1 302 and user node #2 304 influence the activities of user node #4 318. Similarly, user node #1 302, user node #2 304, and user node #3 316 indirectly influence the activities of user node #5 322 via the connection 324 between user node #5 322 and user node #4 318. Similarly, user node #5 322 is indirectly (and weakly) influencing the activities of user node #1.

Consider now the great influence (i.e. thickness of connection 326) of user node #4 318 on the activities of user node #3 316. As a result, user node #2 304 is also influenced by user node #4 318, but in a weaker manner than the influence of user node #1 302 on user node #2 304 because user node #4's influence on the activities of user node #2 304 is indirect, whereas user node #1's influence on the activities of user node #2 304 is direct.

Turning now to the other portion of the influence network 300b schematically illustrated, user node #9 330 has bidirectional connections with user node #10 332 and user node #11 334. In some examples, this may mean that the respective user profiles of user node #10 332 and user node #11 334 have mutual friendships with the user profile associated with user node #9 330. However, because user node #10 332 and user node #11 334 have no other connections, and user node #9 330 itself has no other connections, user node #9's dynamic influence score is relatively low. That is, user node #9 330 is not identified as a lead user because the breadth and depth of user node #9's connections is limited.

The above described systems and methods enable a service provider to track user influence within a social music network, and offer rewards to particularly influential users, i.e., tastemaker users, to encourage their continued participation in the social music network, thereby benefiting both the service provider and the user base.

It will be appreciated that the computing devices described herein may be any suitable computing device configured to execute the programs described herein. For example, the computing devices may be a mainframe computer, personal computer, laptop computer, portable data assistant (PDA), computer-enabled wireless telephone, networked computing device, or other suitable computing device, and may be connected to each other via computer networks, such as the Internet. These computing devices typically include a processor and associated volatile and non-volatile memory, and are configured to execute programs stored in non-volatile memory using portions of volatile memory and the processor. As used herein, the term “program” refers to software or firmware components that may be executed by, or utilized by, one or more computing devices described herein, and is meant to encompass individual or groups of executable files, data files, libraries, drivers, scripts, database records, etc. It will be appreciated that computer-readable media may be provided having program instructions stored thereon, which upon execution by a computing device, cause the computing device to execute the methods described above and cause operation of the systems described above.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. A method for tracking user profile influence in a digital media system, the method comprising:
computing connection weights of connections between a plurality of user nodes, each user node representing a user profile of the digital media system, to thereby generate an influence network, the connection weights being based on implicit activity notifications received at a media server via a plurality of media clients associated with the user nodes;
calculating a dynamic influence score for each of the user nodes based on the connection weights between the user nodes in the influence network;
comparing the dynamic influence scores to an influence score threshold to determine one or more lead user nodes; and
sending an influence reward to the media clients associated with the one or more lead user nodes.

2. The method of claim 1, wherein implicit activity notifications are received at the media server from a first user media client associated with a first user node responsive to performance of one or more of the following implicit activities via the first user media client: play of a second user profile-associated media item, syncing of a second user profile card, rating of a second user profile-associated media item, sending of a second user profile-associated media item, fan addition and/or friend addition of a second user profile, and fan removal and/or friend removal of a second user profile.

3. The method of claim 2, wherein the connection weights are further based on recency and/or frequency of implicit activity performance.

4. The method of claim 1, wherein the connection weights are further based on explicit activity notifications received at the media server from a first user media client associated with a first user node responsive to execution of one or more of the following explicit activities via the first user media client: a friend removal, a friend addition, a first user profile-associated media item send, and a first user profile-associated media playlist send.

5. The method of claim 4, wherein the connection weights are further based on recency and/or frequency of explicit activity execution.

6. The method of claim 1, wherein the calculating a dynamic influence score for each user node is further based on connectedness factors of connections between each user node and other user nodes including one or more of connection directionalities, connection durations, connection distances, number of connections, a number of connections with active user nodes, media client operating sources associated with the user nodes, and dynamic influence scores of the other user nodes.

7. The method of claim 6, wherein connection directionalities are unidirectional or bidirectional, where a unidirectional connection indicates a one-way friendship between a first user node and a second user node or a one-way fan-ship between a first user node and a second user node, and where a bidirectional connection indicates a mutual friendship between a first user node and a second user node.

8. A method for rewarding user profile influence in a digital media system, the method comprising:
receiving a reward at one of a plurality of media clients associated with a target user node from a media server when a dynamic influence score of the target user node representing a target user profile exceeds a dynamic influence score threshold, the dynamic influence score being based on connection weights of connections between the target user node and other user nodes of an influence network, where the other user nodes represent other user profiles of the digital media system, and where the connection weights are based on implicit activity notifications sent to the media server from other user media clients associated with the other user nodes.

9. The method of claim 8, wherein the implicit activity notifications are sent to the media server responsive to performance of one or more of the following implicit activities via the other user media clients: play of a target user profile-associated media item, syncing of a target user profile card, rating of a target user profile-associated media item, sending of a target user profile-associated media item, fan addition and/or friend addition of a target user profile, and fan removal and/or friend removal of a target user profile.

10. The method of claim 8, wherein connection weights are further based on explicit activity notifications sent to the media server from a target user media client associated with the target user node responsive to execution of one or more of the following explicit activities via the target user media client: a friend removal, a friend addition, sending of a target user profile-associated media item, and sending of a target user profile-associated media playlist.

11. The method of claim 8, wherein the dynamic influence score for the target user node is further based on connectedness factors of connections between the target user node and the other user nodes of the influence network, including one or more of connection directionalities, connection durations, connection distances, number of connections, a number of connections with active user nodes, dynamic influence scores of the other user nodes, and media client operating sources of the target user node and the other user nodes.

12. The method of claim 11, wherein connection directionalities are unidirectional or bidirectional, where a unidirectional connection indicates a one-way friendship between the target user node and one of the other user nodes or a one-way fan-ship between the target user node and one of the other user nodes, and where a bidirectional connection indicates a mutual friendship between the target user node and one of the other user nodes.

13. A digital media system for tracking user profile influence, the system comprising:
a media server configured to receive implicit activity notifications from a plurality of media clients responsive to performance of one or more implicit activities via the media clients, said media clients representing a plurality of user nodes, and said user nodes each being associated with a user profile of the digital media system, the media server including:
a processing platform including a computation module configured to:
compute connection weights of connections between the plurality of user nodes to thereby generate an influence network, wherein the connection weights are based on the implicit activity notifications, and are further based on recency and/or frequency of implicit activity performance,
calculate a dynamic influence score for each user node based on connection weights between each user node and one or more other user nodes of the influence network, and
compare the dynamic influence scores to an influence score threshold to determine one or more lead user nodes;
wherein the media server is configured to send an influence reward to one or more media clients associated with the one or more lead user nodes.

14. The system of claim 13, wherein implicit activities performed via a first user media client associated with a first user node include one or more of a play of a second user profile-associated media item, syncing of a second user profile card, rating of a second user profile-associated media item, sending of a second user profile-associated media item, fan addition and/or friend addition of a second user profile, and fan removal and/or friend removal of a second user profile.

15. The system of claim 13, wherein the connection weights are further based on explicit activity notifications received at the media server from a first user media client associated with a first user node responsive to execution of one or more of the following explicit activities via the first user media client: a friend removal, a friend addition, sending of a first user profile-associated media item, and sending of a first user profile-associated media playlist.

16. The system of claim 15, wherein the connection weights are further based on recency and/or frequency of explicit activity execution.

17. The system of claim 13, wherein the dynamic influence score for each user node is further based on connectedness factors of connections between each user node and the other user nodes including one or more of connection directionalities, connection durations, connection distances, number of connections, a number of connections with active user nodes, dynamic influence scores of other user nodes, and media client operating sources associated with each user node.

18. The system of claim 17, wherein connection directionalities include unidirectional connections, where a unidirectional connection indicates a one-way friendship between a first user node and a second user node or a one-way fan-ship between a first user node and a second user node.

19. The system of claim 18, wherein connection directionalities include bidirectional connections, where a bidirectional connection indicates a mutual friendship between a first user node and a second user node.

20. The system of claim 18, wherein the media client operating sources include one or more of a software-developer computing device, a third party computing device, and a network-based platform.
